(19) United States
(12) Patent Application Publication
(10) Pub. No.: US 2024/0383311 A1
(43) Pub. Date: Nov. 21, 2024

(54) AIR DELIVERY SYSTEM

(71) Applicant: Ford Global Technologies, LLC, Dearborn, MI (US)

(72) Inventors: Vishal Vinayak Nageshkar, Windsor (CA); John Craig Elson, Farmington Hills, MI (US); Marcos Silva Kondrad, Macomb Township, MI (US); Kevin Wayne Preuss, Ortonville, MI (US)

(73) Assignee: Ford Global Technologies, LLC, Dearborn, MI (US)

(21) Appl. No.: 18/197,893

(22) Filed: May 16, 2023

(51) Int. Cl. B60H 1/00; B60H 1/24

(52) U.S. Cl. CPC B60H 1/00871; B60H 1/00742; B60H 1/245; B60H 1/246

(57) ABSTRACT

An air delivery system for a vehicle comprises an HVAC system and an air duct fluidly coupled with the HVAC system. The air delivery system comprises a rail extending parallel to the air duct. The system comprises a module having a rail rider slidably coupled with the rail. The module defines an air inlet in selective fluid communication with the air duct. The module defines an air chamber in fluid communication with the air inlet. The module comprises an air register fluidly coupled with the air chamber. The air delivery system comprises a sensor that senses at least one of a distance between the module and the HVAC system; and an air flow therebetween. The air delivery system comprises a controller that controls the air flow based upon at least one of the measured distance between the module and the HVAC system and the air flow therebetween.

### FIELD OF THE DISCLOSURE

The present disclosure generally relates to an air delivery system, and more particularly relates to an air delivery system that delivers an air through a translatable air outlet to an interior of a vehicle.

### BACKGROUND OF THE DISCLOSURE

Motor vehicles are commonly equipped with various air vents to deliver air to the interior of the vehicle. The air vents may direct air around the interior from a fixed location. It would be desirable to provide air from a dynamic location that takes into consideration the location of the occupant.

### SUMMARY OF THE DISCLOSURE

According to a first aspect of the present disclosure, an air delivery system for a vehicle, the air delivery system including a heating, ventilation, and air conditioning system. The air delivery system including an air duct fluidly coupled with the heating, ventilation, and air conditioning system. The air delivery system including a follower feature assembly. The follower feature assembly selectively defines an air outlet in fluid communication with the air duct. The follower feature assembly is articulated to translate the defined air outlet along a surface of an interior of the vehicle. The air delivery system including a first sensor configured to measure at least one of a distance between the air outlet and the heating, ventilation, and air conditioning system and an air flow therebetween. The air delivery system including a controller configured to control the air flow based upon the at least one of the distance between the air outlet and the heating, ventilation, and air conditioning system and the air flow therebetween.

Embodiments of the first aspect of the present disclosure can include any one or a combination of the following features:
the follower feature assembly is articulated to translate the defined air outlet along a surface of floor of the vehicle;
a module defining an air chamber including a cam assembly disposed within the air chamber, wherein the cam assembly engages the follower feature assembly;
the follower feature assembly including a gate hingedly coupled with the air duct, a protrusion extending from the gate, wherein the protrusion comprises an apex, a hinge, wherein the gate pivots toward an open position about the hinge away from the cam assembly in response to the cam assembly engaging the protrusion, wherein the gate in the open position defines the air outlet, and a spring coupled with the hinge that biases the gate toward a closed position;
the cam assembly including a cam holder and a cam, wherein the cam engages the protrusion, and wherein the cam pivots the gate toward the open position in response to the cam engaging the apex of the protrusion;
the follower feature assembly including a spool-tensioned cover having a static end and a dynamic end, wherein the spool-tensioned cover is coupled with the follower feature assembly at the air outlet, wherein the spool-tensioned cover is coupled with the vehicle at the static end, and wherein the spool-tensioned cover spools at least one of the static end and the dynamic end as the follower feature assembly is articulated to translate the defined air outlet along the surface of the interior of the vehicle toward the static end;
the follower feature assembly including a telescopic tube having a plurality of sealing gaskets between a respective plurality of telescopic sections of the telescopic tube,
the follower feature assembly includes a corrugated expansion tube;
the follower feature assembly includes a zipper gasket and the cam assembly includes a first zipper and a second zipper oriented opposite of the first zipper, wherein one chosen from the first zipper and the second zipper unclasps the zipper gasket as the module slides toward the one chosen from the first zipper and the second zipper, and further wherein the other chosen from the first zipper and the second zipper clasps the zipper gasket as the module slides toward the other one chosen from the first zipper and the second zipper; and
a widener inserted into the zipper gasket between the first zipper and the second zipper.

According to a second aspect of the present disclosure, an air delivery system for a vehicle includes an air duct fluidly coupled with a heating, ventilation air conditioning system, the air duct defining an opening. The air delivery system also includes a follower feature assembly coupled with the air duct. The follower feature assembly restricts the opening into an air outlet. The follower feature assembly selectively restricts fluid communication between the air duct and the air outlet. The air delivery system also includes a rail disposed on an interior of the vehicle. The air delivery system also includes an overhead module comprising a rail rider slidably coupled with the rail. The overhead module thus translates along the rail via the rail and rail rider. The overhead module also includes a cam assembly that engages the follower feature assembly to increase fluid communication between the air duct and air outlet. The overhead module defines an air chamber in selective fluid communication with the air outlet. The air delivery system also includes a first sensor that may be a location sensor that measures a distance between the overhead module and the heat ventilation air conditioning system. The air delivery system also includes a controller that controls an air flow leaving the heat ventilation air conditioning system based on the distance measured by the location sensor.

Embodiments of the second aspect of the present disclosure can include any one or a combination of the following features:
an arcuate cam holder disposed inside the air chamber; and at least one cam coupled with the sloped cam holder at a first apex of the cam holder, wherein the at least one cam moves the follower feature assembly to widen the air outlet upon the overhead module being slid along the rail;
the at least one cam is a plurality of cams gradated along the sloped cam holder, wherein the plurality of cams moves the follower feature assembly varying degrees to widen the air outlet upon the overhead module being slid along the rail;
a plurality of gates operable between an open position and a closed position hingedly coupled with the air duct at the opening; a sinusoidal protrusion extending toward an interior of the vehicle, the sinusoidal protrusion coupled with each gate, wherein the sinusoidal protrusion selectively engages the cam assembly, and a spring-loaded hinge coupled with each gate biasing the gate toward the closed position;
at least one of: a zipper gasket; a spool-tensioned cover; a telescopic tube; and a corrugated expansion tube;
the module translates along the rail in response to at least one of an actuator and an occupant manually translating the module; and
a light; a power supply port; a visor; and a human-machine interface.

According to a third aspect of the present disclosure, an air delivery system for a vehicle includes an overhead module defining an air chamber in fluid communication with an air inlet, a forward air register, and a rearward air register. The overhead module includes a cam assembly disposed within the air chamber. The cam assembly includes an arcuate cam holder and a plurality of cams coupled with the arcuate cam holder. The plurality of cams extend from the arcuate cam holder parallelly. The overhead module also includes a rail rider coupled with a rail disposed on an interior of the vehicle. The overhead module thus slides and halts along the rail. The air delivery system further includes a heating, ventilation air conditioning system and an air duct fluidly coupled with the heating, ventilation air conditioning system. The air duct includes a follower feature assembly defining an air outlet in selective fluid communication with the air duct. The follower feature includes a plurality of gates each hingedly coupled with the air duct and a sinusoidal protrusion having a second apex. The sinusoidal protrusion extends from each gate toward the interior of the vehicle. The sinusoidal protrusion is configured to engage one cam of the plurality of cams in response to the overhead module sliding to at least one gate. The air outlet and the air inlet are in fluid communication in response to at least one gate defining the air outlet. The follower feature assembly also includes a spring-loaded hinge biasing the gate to restrict fluid communication between the air duct and the air outlet. The air delivery system also includes a first sensor configured to measure an air flow between the heating, ventilation air conditioning system and at least one of the forward air register and rearward air register.

Embodiments of the third aspect of the disclosure can include the following feature.
a proximal end coupled with the spring-loaded hinge and a distal end, and wherein the sinusoidal protrusion is coupled with the proximal end.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of an occupant seated in an interior of a vehicle and an air delivery system delivering an air flow through an overhead module;

FIG. 2 is a perspective view of the interior of the vehicle having an overhead module slidably coupled with rails;

FIG. 3 is a front perspective view of the overhead module having an air chamber and air register;

FIG. 4A is a side x-ray view of the overhead module having a cam assembly, air chamber, and air register fluidly coupled with a follower feature assembly;

FIG. 4B is an inside view of an air duct coupled with a follower feature assembly in a closed position;

FIG. 4C is an inside view of an air duct coupled with the follower feature assembly in a variety of open and closed positions engaging a cam assembly;

FIG. 4D is a front perspective view of a gate of the follower feature assembly in a closed position;

FIG. 4E is a front perspective view of the gate in a fully open position allowing the air flow to leave the air duct and an air outlet;

FIG. 5A is a side perspective view of the gate in a closed position with having the protrusion coupled with a distal end of the gate;

FIG. 5B is a side perspective view of the gate in the open position with having a protrusion coupled with a distal end of the gate engaging a cam to allow the air flow to leave the air duct and the air outlet;

FIG. 6A is a side profile view of the overhead module and the follower feature assembly having a spool-tensioned cover that spools in a circular fashion;

FIG. 6B is a side profile view of the overhead module and the follower feature assembly having a spool-tensioned cover that spools in a stacked fashion;

FIG. 6C is a side profile of the air delivery system with the follower feature assembly having a spool-tensioned cover that spools in a circular fashion;

FIG. 6D is a side profile view of the air delivery system with the follower feature assembly having a spool-tensioned cover that spools in a stacked fashion

FIG. 7 is a side profile view of the overhead module and the follower feature assembly having telescopic tube;

FIG. 8 is a side profile view of the overhead module and the follower feature assembly having a corrugated expansion tube;

FIG. 9 is a side perspective view of the overhead module having a cam assembly having a first zipper and a second zipper and follower feature assembly having a zipper gasket;

FIG. 10A is a top perspective view of the air delivery system disposed on a floor of the vehicle; and

FIG. 10B is a side perspective view of the air delivery system of FIG. 10A.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

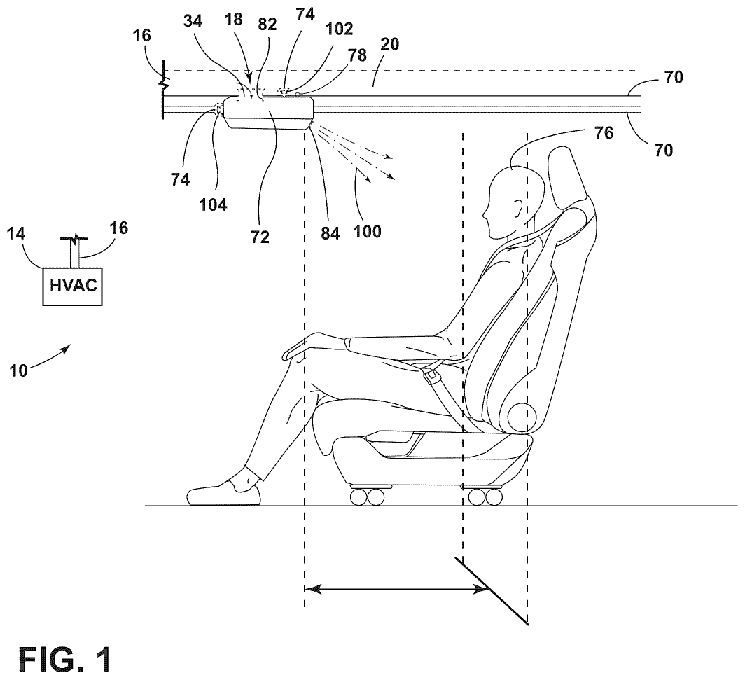

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an air delivery system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

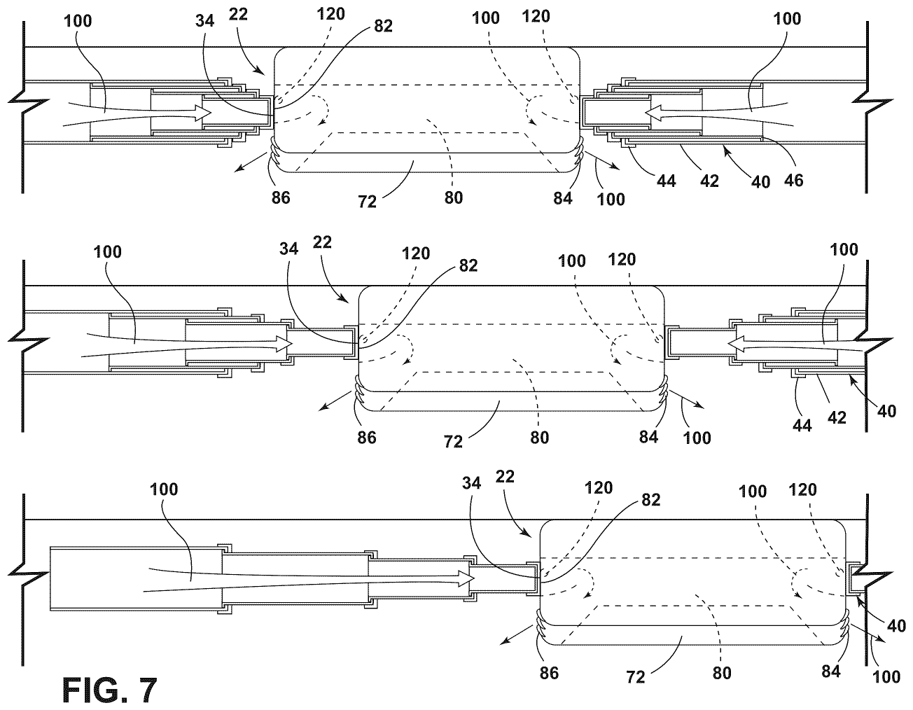

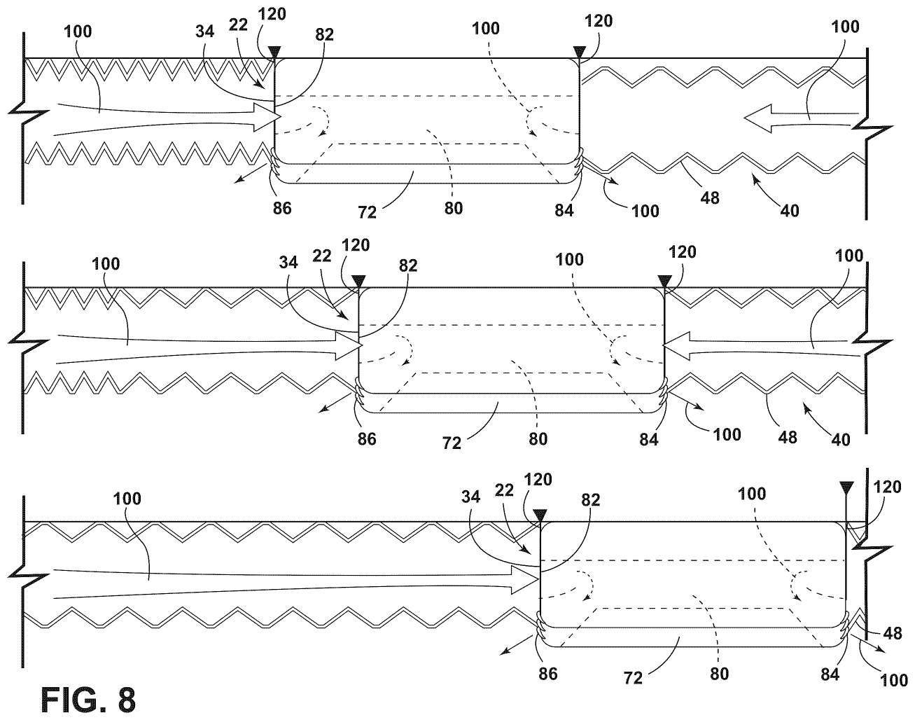

With reference to FIGS. 1-10B, reference numeral 10 generally designates an air delivery system for a vehicle 12. The air delivery system 10 includes a heating, ventilation and air conditioning (HVAC) system 14. The air delivery system 10 also includes an air duct 16 in fluid communication with the HVAC system 14. The air duct 16 may extend longitudinally, laterally, vertically, or a combination thereof within the vehicle 12. The air duct 16 defines an opening 18 in fluid communication with the air duct 16. The opening 18 may be defined by a lateral side 20 of the air duct 16 that interfaces a floor 134, a ceiling, or wall of the vehicle 12. The opening 18 may extend an entire length of the air duct 16. Additionally, or alternatively, the opening 18 may extend a length less than the entire length of the air duct 16. The air duct 16 comprises a follower feature assembly 22. Examples of the follower feature assembly 22 are not limited to but may include a slide cover 132.

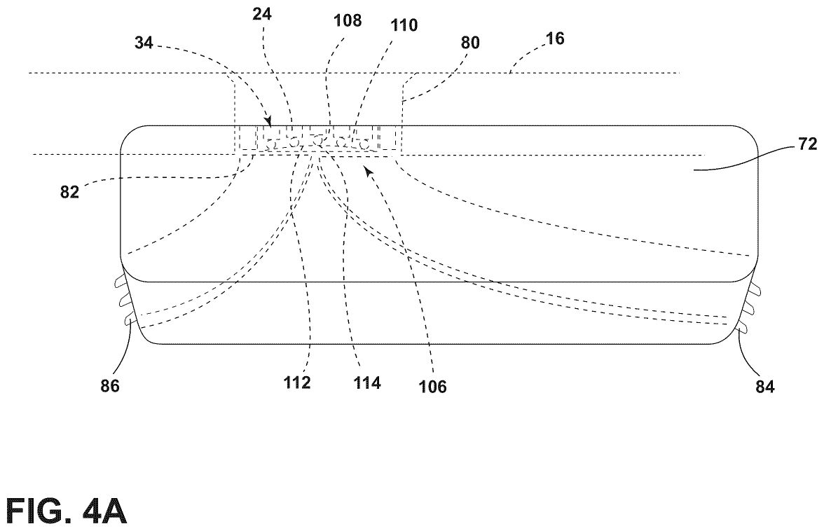

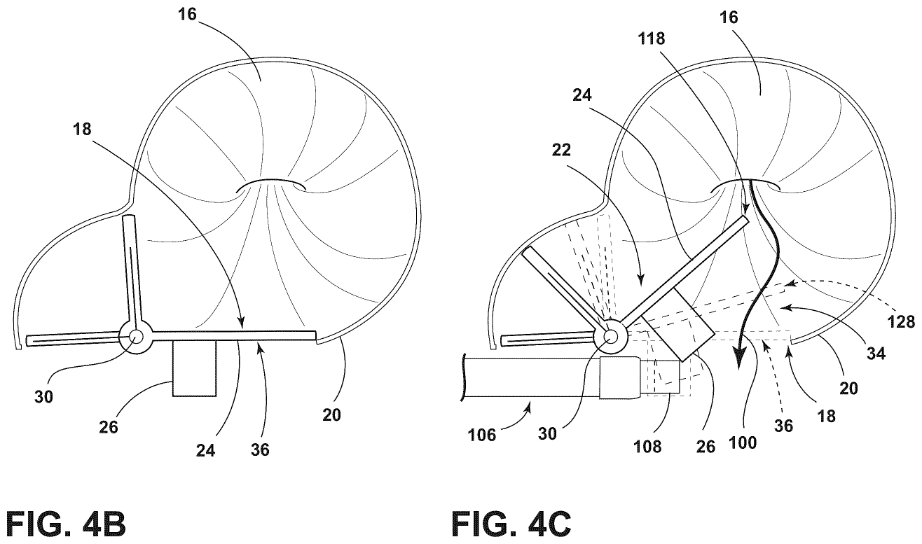

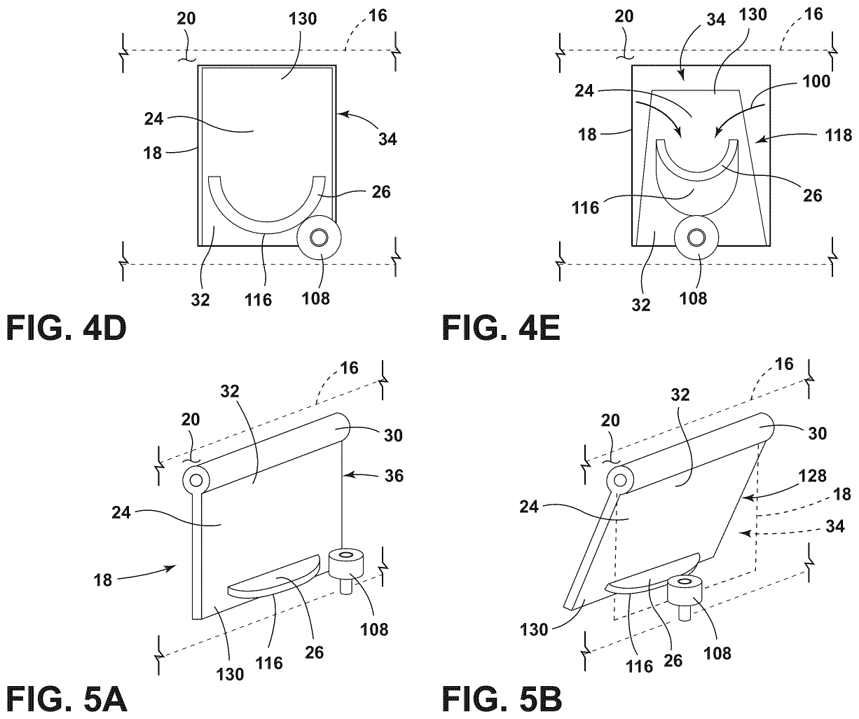

With reference to FIGS. 4A-9, the follower feature assembly 22 may comprise a plurality of gates 24. Each gate 24 of the plurality of gates comprises a sinusoidal protrusion 26 that extends toward an interior 28 of the vehicle 12. The follower feature assembly 22 that comprises a plurality of gates 24 also comprises a spring-loaded hinge 30 coupled with a proximal end 32 of each gate 24. The spring-loaded hinge 30 is coupled with the lateral side 20 of the air duct 16. The follower feature assembly 22 restricts the opening 18 into an air outlet 34. The air outlet 34 is in selective fluid communication with the air duct 16. The spring-loaded hinge 30 biases each gate 24 toward a closed position 36 such that fluid communication between the air outlet 34 and the air duct 16 is restricted.

The follower feature assembly 22 may comprise at least one rim 38. The at least one rim 38 may define the air outlet 34. The follower feature assembly 22 may comprise a telescopic tube 40. The telescopic tube 40 comprises telescopic sections 42 with a gasket 44 therebetween. The gasket 44 may be comprised of foam or another flexible material. The telescopic tube 40 may also comprise a spring-loaded tab 46 between each telescopic section 42 to ensure only one telescopic section 42 moves at a time. The follower feature assembly 22 may comprise a corrugated expansion tube 48.

The follower feature assembly 22 may comprise a zipper gasket 50. The zipper gasket 50 may define the air outlet 34 via compression force 126 biasing the zipper gasket 50 into a first side 52 spaced apart from a second side 54. The zipper gasket 50 may also define the air outlet 34 via a widener 56 inserted into the zipper gasket 50 between the first side 52 and the second side 54. The widener 56 and compression force 126 provide space between the first side 52 and the second side 54 so that the air outlet 34 is defined. Additionally, or alternatively, the follower feature assembly 22 may comprise a plurality of wideners 56 inserted into the zipper gasket 50 between the first side 52 and the second side 54.

The follower feature assembly 22 may comprise a spool-tensioned cover 58. The corrugated expansion tube 48, the telescopic tube 40, the zipper gasket 50, and the spool-tensioned cover 58 each comprise a static end 62 and a dynamic end 64. The spool-tensioned cover 58 may comprise a plurality of adhesive couplers 60 that selectively coupled to the air duct 16 to restrict fluid communication between the air outlet 34 and the air inlet 82. The spool-tensioned cover 58 may spool in a circular fashion 66 or in a stacked fashion 68. The corrugated expansion tube 48 may be more rigid at the static end 62 and less rigid at the dynamic end 64 such that the dynamic end 64 is less stiff than the static end 62.

With reference to FIGS. 1-3 and 6-9, the air delivery system 10 may also comprise a rail 70 on the underside of a roof of the vehicle 12 in the interior 28. Additionally, or alternatively, the rail 70 may be on a floor 134, a wall, a cargo space, or elsewhere within the vehicle 12. The rail 70 extends along the length of the air duct 16. The air delivery system 10 also comprises a module 72. The module 72 may be an overhead module. The module 72 comprises a rail rider 74. The rail rider 74 slidably couples with the rail 70 such that the module 72 slides along the rail 70. The module 72 may slide along the rail 70 via an actuator 78 (i.e., an electric motor). Additionally, or alternatively, the module 72 may slide along the rail 70 in response to an occupant 76 manually sliding the module 72. The module 72 defines an air chamber 80, an air inlet 82, and an air register 84. The air chamber 80 is in fluid communication with the air inlet 82 and the air register 84. Additionally, or alternatively, the module 72 may comprise a plurality of air inlets 82 and a plurality of air registers 84 in fluid communication with the air chamber 80. The plurality of air registers 84 may be a forward air register 84 and a rearward air register 86. The air inlet 82 is in selective fluid communication with the air outlet 34. The spool-tensioned cover 58 may spool at least one chosen from the static end 62 of the spool-tensioned cover 58 and the dynamic end 64 of the spool-tensioned cover 58 in response to the module 72 sliding closer to the static end 62.

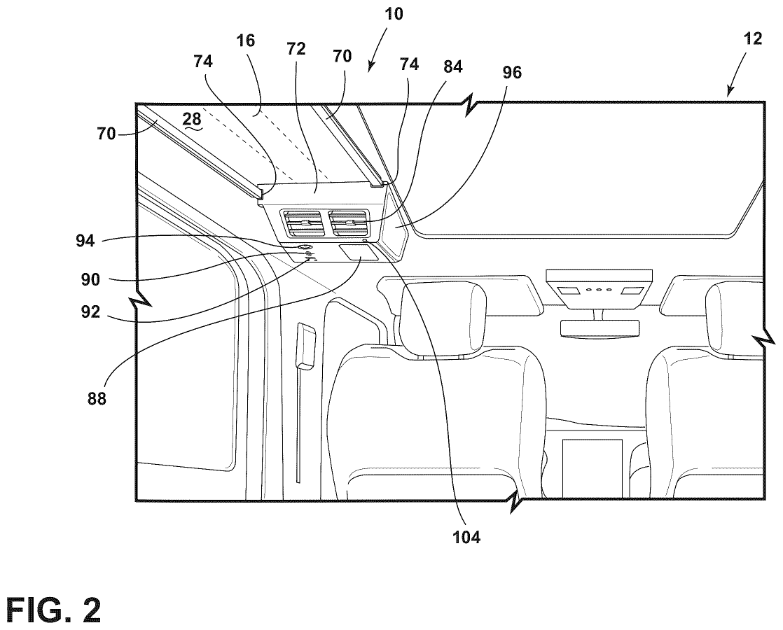

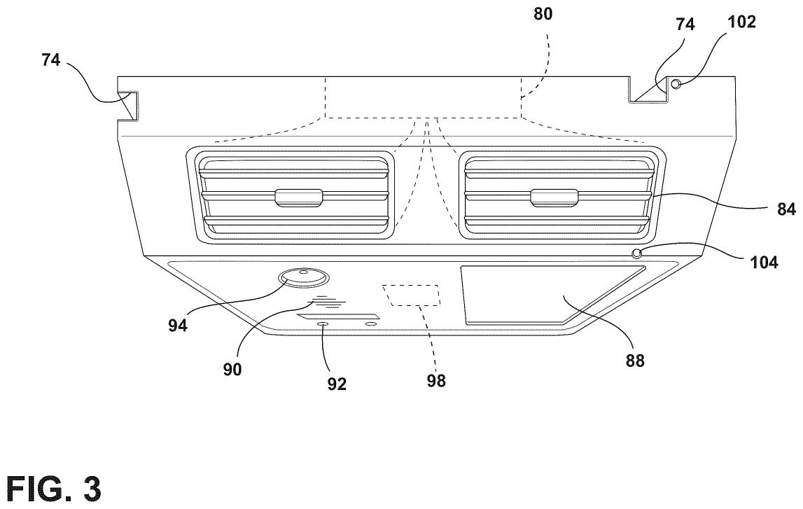

With reference to FIGS. 2 and 3, the module 72 as depicted is an overhead module extending above the seated occupant 76. The module 72 may comprise a human-machine interface (HMI) 88. The module may also comprise a speaker 90, a power supply port 92, a light 94, or a deployable visor 96. The HMI 88 is configured to signal a controller 98 to control at least one of an air flow 100 from the HVAC system 14 or leaving the air register 84; the light 94; the speaker 90; or whether the module 72 slides or halts along the rail 70.

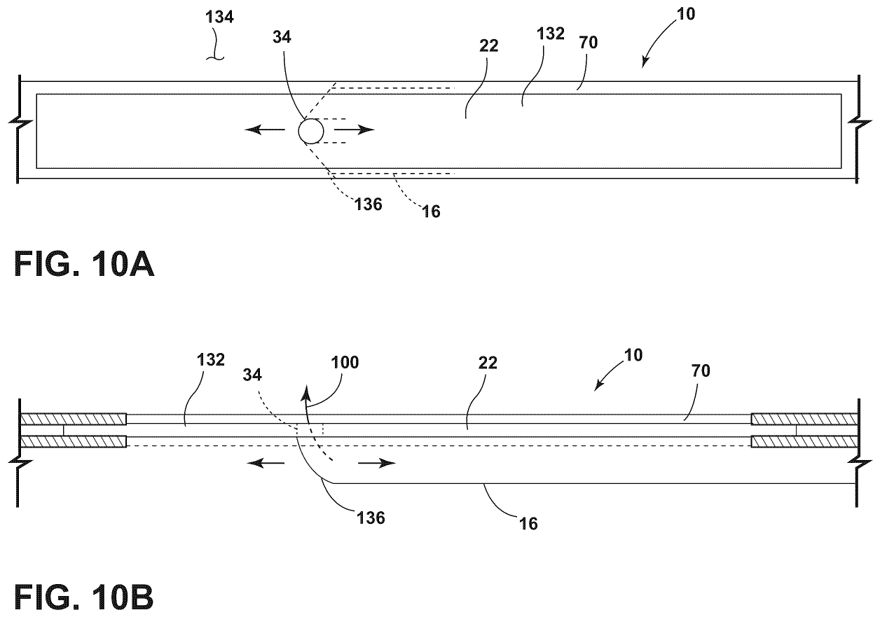

With reference to FIGS. 10A and 10B, the air delivery system 10, as depicted, may be disposed on the floor 134 of the vehicle 12. The follower feature assembly 22 comprises the slide cover 132. The slide cover 132 of the follower feature assembly 22 may be articulated to translate parallel to and partially within the rail 70. The slide cover 132 may define the air outlet 34. The air outlet 34, therefore, translates with the slide cover 132 such that the air flow 100 is delivered where the air outlet 34 is translated. The solid arrows shown in FIGS. 10A and 10B depict the translative movement of the air outlet 34. The air duct 16 may bend and/or narrow to direct the air flow 100 from within the air duct 16 toward exiting the air outlet 34. The portion of the air duct 16 that bends and narrows may be a bend 136. The bend 136 may translate with the slide cover 132 of the follower feature assembly 22. The bend 136 may be coupled with the slide cover 132 at the air outlet 34. The bend 136 may be slidably coupled with the air duct 16.

With further reference to FIG. 3, a first sensor 102 is configured to measure a distance between the module 72 and the HVAC system 14. A second sensor 104 is configured to measure the air flow 100 between the HVAC system 14 and the air register 84. The controller 98 is configured to control the air flow 100 based upon the measurement of the first sensor 102, the measurement of the second sensor 104, and an occupant 76 input with the HMI 88. Based on Bernoulli's Equation, for example, the controller 98 also controls the air flow 100 based upon pre-existing constants specific to the air delivery system 10 (for example a frictional factor of at least the air duct 16 and follower feature assembly 22, a cross-sectional area of the air duct 16, or an acceleration due to gravity). Additionally, or alternatively, the controller 98 may control the air flow 100 based on a closed loop.

With reference to FIGS. 4A-9, the module 72 also comprises a cam assembly 106 disposed within the air chamber 80. The cam assembly 106 comprises at least one cam 108. The at least one cam 108 may be configured to engage the sinusoidal protrusion 26 in response to the module 72 sliding to of the plurality of gates 24 along the air duct 16 and the rail 70. The cam assembly 106 may comprise a cam holder 110. The cam holder 110 may be arcuate with a convex surface 112.

With reference to FIGS. 4A-5B, the at least one cam 108 may be a plurality of cams coupled with the cam holder 110 extending away from the cam holder 110. Additionally, or alternatively, the plurality of cams 108 may be coupled with the convex surface 112. The cam holder 110 comprises a first apex 114 and the sinusoidal protrusion 26 comprises a second apex 116. The at least one cam 108 that engages the sinusoidal protrusion 26 pivots the respective gate of the plurality of gates 24 toward an open position 128 such that the air outlet 34 and the air inlet 82 are in fluid communication. The at least one cam 108 coupled with the cam holder 110 on the first apex 114 that engages the sinusoidal protrusion 26 at the second apex 116 pivots the respective gate of the plurality of gates 24 to a fully open position 118. The plurality of cams 108 may extend from the cam holder 110 such that one cam of the plurality of cams 108 that does not engage the sinusoidal protrusion 26 at the first apex 114 and the second apex 116 pivots the respective gate of the plurality of gates 24 toward the open position 128 that is less than the fully open position 118. The sinusoidal protrusion 26 may be coupled with each gate 24 at the proximal end 32 of the gate 24. Additionally, or alternatively, the sinusoidal protrusion 26 may be coupled with the distal end 130 of each gate 24.

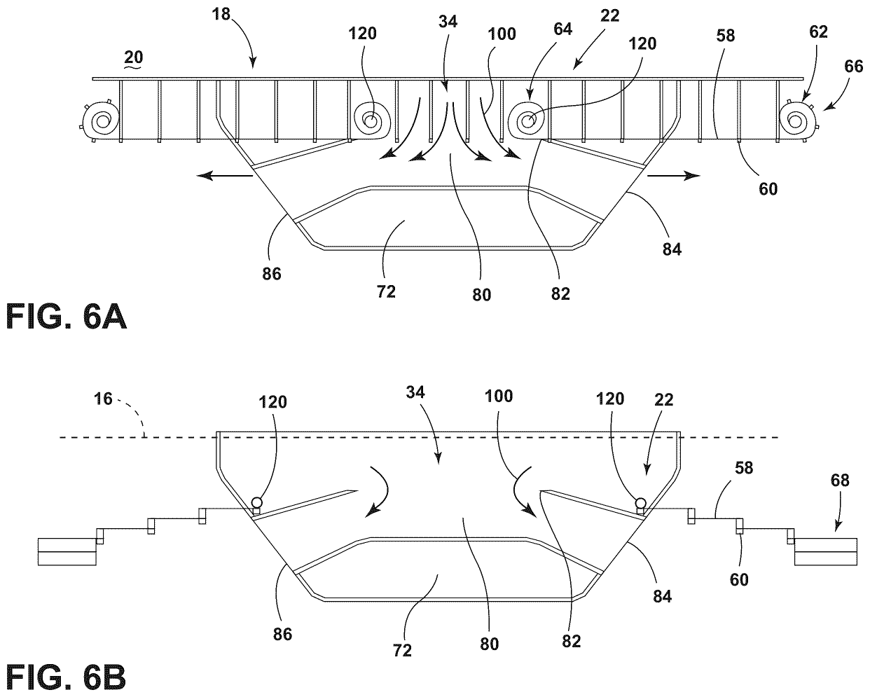

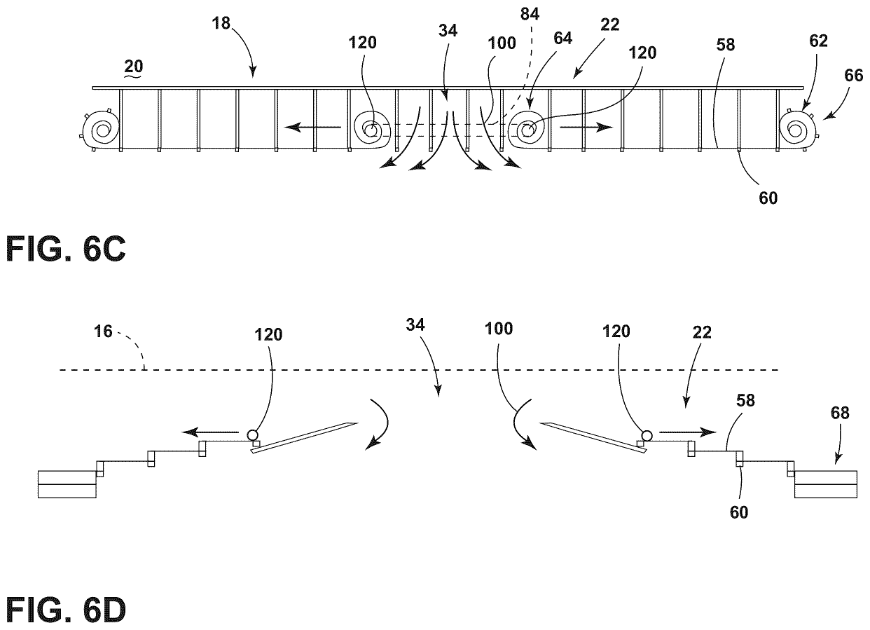

With reference to FIGS. 6-8, the cam assembly 106 may comprise a coupler 120. The coupler 120 may couple with the at least one rim 38. The at least one rim 38 coupled with the coupler 120 follows the coupler 120 as the module 72 slides along the rail 70 such that the air outlet 34 is defined by the at least one rim 38 wherever the module 72 is along the rail 70. Additionally, or alternatively, the coupler 120 may couple with the spool-tensioned cover 58 such that the dynamic end 64 spools around the coupler 120. Additionally, or alternatively, the cam assembly 106 may comprise a plurality of couplers 120.

With reference to FIGS. 6C-6D, the air delivery system 10 may be disposed on the interior 28 of the vehicle 12. Additionally, or alternatively, the air delivery system 10 may deliver the air flow 100 without the use of the module 72. The air outlet 34 may be fluidly coupled with the forward register 84. The forward register 84 may be directly coupled with the plurality of couplers 120 such that the follower feature assembly 22 is articulated via the forward air register 84 to translate the air outlet 34 along the interior 28 of the vehicle 12. FIGS. 6C and 6D illustrate the air delivery system 10 delivering the air flow 100 without the use of the module 72 with the follower feature assembly 22 that includes a spool tensioned cover 58; however, additional and alternative examples of the air delivery system 100 with the follower feature assembly 22 that includes other features are to be understood by one skilled in the art.

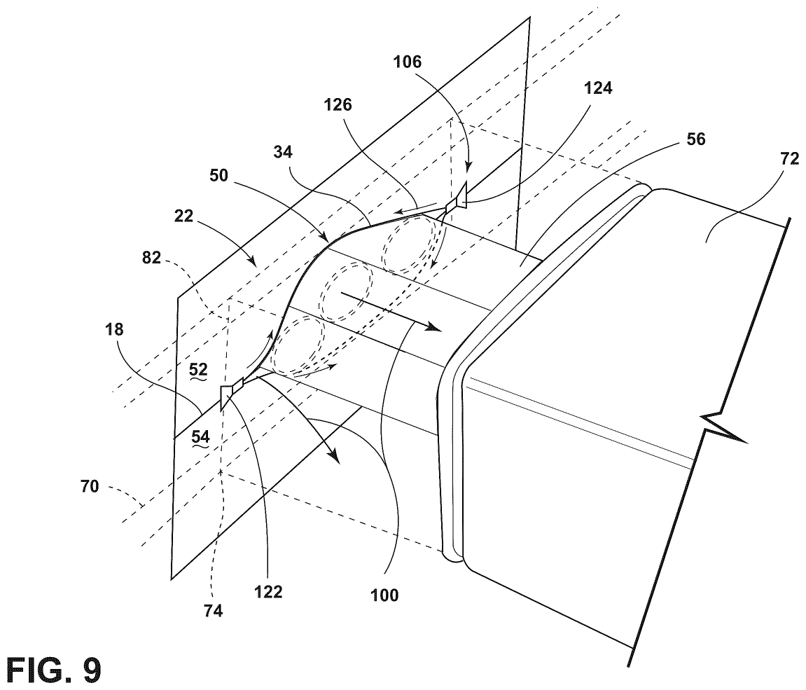

With reference to FIG. 9, the cam assembly 106 may comprise a first zipper 122 and a second zipper 124. The first zipper 122 is oriented opposite the second zipper 124. The first zipper 122 and the second zipper 124 may be spaced from one another such that they apply the compression force 126 to the zipper gasket 50 as the module 72 slides toward one chosen from the first zipper 122 and toward the second zipper 124. The air outlet 34 defined by the zipper gasket 50 may be lens shaped with the compression force 126 being applied by the first zipper 122 and the second zipper 124 at each of the vertices of the lens-shaped air outlet 34. The compression force 126 is caused by the first zipper 122 and the second zipper 124 being spaced apart by a distance that is less than if the zipper gasket 50 were fully extended. One chosen from the first zipper 122 and the second zipper 124 locks the zipper gasket 50 and the other not chosen of the first zipper 122 and the second zipper 124 unlocks the zipper gasket 50 at a same rate.

The air delivery system advantageously provides for a sliding module on a vehicle that provides air flow from an HVAC system and controls the air flow based on a sensed distance or sensed air flow between the module and the HVAC system. This provides a desired air flow to an occupant that may be seated in a variety of locations with the interior of the vehicle. Additionally, for an occupant that may be seated in a moveable seat (i.e., a swivel seat), this air delivery system allows the air flow to reach that occupant at all times.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An air delivery system for a vehicle, the air delivery system comprising:
a heating, ventilation, and air conditioning system;
an air duct fluidly coupled with the heating, ventilation, and air conditioning system;
a follower feature assembly, wherein the follower feature assembly selectively defines an air outlet in fluid communication with the air duct, wherein the follower feature assembly is articulated to translate the defined air outlet along a surface of an interior of the vehicle;
a first sensor configured to measure at least one of a distance between the air outlet and the heating, ventilation, and air conditioning system and an air flow therebetween; and
a controller configured to control the air flow based upon the at least one of the distance between the air outlet and the heating, ventilation, and air conditioning system and the air flow therebetween.

2. The air delivery system of claim 1, wherein the follower feature assembly is articulated to translate the defined air outlet along a surface of floor of the vehicle.

3. The air delivery system of claim 1, further comprising a module defining an air chamber, the module comprising a cam assembly disposed within the air chamber, wherein the cam assembly engages the follower feature assembly.

4. The air delivery system of claim 3, wherein the follower feature assembly comprises:
a gate hingedly coupled with the air duct;
a protrusion extending from the gate, wherein the protrusion comprises an apex;
a hinge, wherein the gate pivots toward an open position about the hinge away from the cam assembly in response to the cam assembly engaging the protrusion, wherein the gate in the open position defines the air outlet; and
a spring coupled with the hinge that biases the gate toward a closed position.

5. The air delivery system of claim 4, wherein the cam assembly comprises:
a cam holder; and
a cam, wherein the cam engages the protrusion, and wherein the cam pivots the gate toward the open position in response to the cam engaging the apex of the protrusion.

6. The air delivery system of claim 1, wherein the follower feature assembly comprises a spool-tensioned cover having a static end and a dynamic end, wherein the spool-tensioned cover is coupled with the follower feature assembly at the air outlet, wherein the spool-tensioned cover is coupled with the vehicle at the static end, and wherein the spool-tensioned cover spools at least one of the static end and the dynamic end as the follower feature assembly is articulated to translate the defined air outlet along the surface of the interior of the vehicle toward the static end.

7. The air delivery system of claim 1, wherein the follower feature assembly comprises a telescopic tube having a plurality of sealing gaskets between a respective plurality of telescopic sections of the telescopic tube.

8. The air delivery system of claim 1, wherein the follower feature assembly comprises a corrugated expansion tube.

9. The air delivery system of claim 3, wherein the follower feature assembly comprises a zipper gasket and the cam assembly comprises a first zipper and a second zipper oriented opposite of the first zipper, wherein one chosen from the first zipper and the second zipper unclasps the zipper gasket as the module slides toward the one chosen from the first zipper and the second zipper, and further wherein the other chosen from the first zipper and the second zipper clasps the zipper gasket as the module slides toward the other one chosen from the first zipper and the second zipper.

10. The air delivery system of claim 9, further comprising:
a widener inserted into the zipper gasket between the first zipper and the second zipper.

11. An air delivery system for a vehicle, the air delivery system comprising:
an air duct fluidly coupled with a heating, ventilation air conditioning system, the air duct defining an opening;
a follower feature assembly coupled with the air duct, wherein the follower feature assembly restricts the opening into an air outlet, and wherein the follower feature assembly selectively restricts fluid communication between the air duct and the air outlet;
a rail disposed on an interior of the vehicle;
an overhead module comprising:
a rail rider slidably coupled with the rail, wherein the overhead module translates along the rail via the via the rail and rail rider;
a cam assembly that engages the follower feature assembly to increase fluid communication between the air duct and air outlet, wherein the overhead module defines an air chamber in selective fluid communication with the air outlet; and
an air register in fluid communication with the air chamber;
a location sensor that measures a distance between the overhead module and the heat ventilation air conditioning system; and
a controller that controls an air flow leaving the heating, ventilation air conditioning system based on the distance measured by the location sensor.

12. The air delivery system of claim 11, wherein the cam assembly comprises:
an arcuate cam holder disposed inside the air chamber; and
at least one cam coupled with the arcuate cam holder at a first apex of the arcuate cam holder, wherein the at least one cam moves the follower feature assembly to widen the air outlet upon the overhead module being slid along the rail.

13. The air delivery system of claim 12, wherein the at least one cam is a plurality of cams gradated along the arcuate cam holder, wherein the plurality of cams moves the follower feature assembly varying degrees to widen the air outlet upon the overhead module being slid along the rail.

14. The air delivery system of claim 11, wherein the follower feature assembly comprises:
a plurality of gates operable between an open position and a closed position hingedly coupled with the air duct at the opening;
a sinusoidal protrusion extending toward an interior of the vehicle, the sinusoidal protrusion coupled with each gate, wherein the sinusoidal protrusion selectively engages the cam assembly; and
a spring-loaded hinge coupled with each gate biasing each gate toward the closed position.

15. The air delivery system of claim 11, wherein the follower feature assembly comprises at least one of:
a zipper gasket,
a spool-tensioned cover;
a telescopic tube; and
a corrugated expansion tube.

16. The air delivery system of claim 15, the air delivery system further comprising:
a widener extending from the air chamber into the air duct.

17. The air delivery system of claim 11, wherein the overhead module translates along the rail in response to at least one of an actuator and an occupant manually translating the module.

18. The air delivery system of claim 11, further comprising:
a light;
a power supply port;
a visor; and
a human-machine interface.

19. An air delivery system for a vehicle, the air delivery system comprising:
an overhead module defining an air chamber in fluid communication with an air inlet, a forward air register, and a rearward air register, wherein the overhead module comprises;
a cam assembly disposed within the air chamber, wherein the cam assembly comprises:
an arcuate cam holder;
a plurality of cams coupled with the arcuate cam holder, wherein the plurality of cams extend from the arcuate cam holder parallelly; and
a rail rider coupled with a rail disposed on an interior of the vehicle, wherein the overhead module slides and halts along the rail;
a heating, ventilation, and air conditioning system;
an air duct fluidly coupled with the heating, ventilation air conditioning system, and wherein the air duct comprises:
a follower feature assembly selectively defining an air outlet in fluid communication with the air duct, wherein the follower feature assembly comprises:
a plurality of gates each hingedly coupled with the air duct;
a sinusoidal protrusion having an apex, wherein the sinusoidal protrusion extends from each gate toward the interior of the vehicle, wherein the sinusoidal protrusion is configured to engage one cam of the plurality of cams in response to the overhead module sliding to at least one gate of the plurality of gates, and wherein the air outlet and the air inlet are in fluid communication in response to at least one gate defining the air outlet; and
a spring-loaded hinge biasing the gate to restrict fluid communication between the air duct and the air outlet;
a first sensor configured to measure an air flow between the heating, ventilation air conditioning system and at least one of the forward air register and rearward air register;
a second sensor configured to measure a distance between the overhead module and the heating, ventilation air conditioning system; and
a controller configured to control the air flow based on at least one the measured air flow and the distance.

20. The air delivery system of claim 19, wherein each gate of the plurality of gates comprises a proximal end coupled with the spring-loaded hinge and a distal end, and wherein the sinusoidal protrusion is coupled with the proximal end.
